(19) United States
(12) Patent Application Publication
(10) Pub. No.: US 2005/0281049 A1
(43) Pub. Date: Dec. 22, 2005

(54) Illumination unit and liquid crystal display device using the unit

(76) Inventor: Daisuke Itou, Osaka (JP)

Correspondence Address: MCDERMOTT WILL & EMERY LLP, 600 13TH STREET, N.W., WASHINGTON, DC, 20005-3096, US

(21) Appl. No.: 10/523,788

(22) PCT Filed: Aug. 12, 2002
(86) PCT No.: PCT/JP02/08228

§ 371 Date: Feb. 9, 2005

(51) Int. Cl. F21V 7/04

(52) U.S. Cl. 362/609

(57) ABSTRACT

The present invention is aimed at solving a problem that a non-uniform luminance and white uneveness which may be caused by contact between a reflecting sheet and a protecting member. A light source side end portion (3a) of a reflecting sheet (3) and a protecting member (5) are located with a spacing (H) between them for preventing contact between them. The spacing (H) for preventing contact between them may be obtained by decreasing a protruding length of the light source side end portion (3a) of the reflecting sheet (3), by displacing a light source (2), or by decreasing diameters of the light source (2) and the protecting member (5).

### TECHNICAL FIELD

The present invention relates to a lighting unit provided with a light source on a side surface of a light guiding plate and to a liquid crystal display device using the same.

### BACKGROUND ART

Recently, a liquid crystal display device has been widely used as a display device of an information device such as a notebook-type personal computer, a word processor and the like, or as a display device of a video device such as a portable television, a video movie, a car navigation system and the like, by taking advantage of a characteristic in which the liquid crystal display device is light, small and thin, and consumes small electricity. Such liquid crystal display device typically has a structure in which a display element is illuminated from behind by a built-in lighting unit for obtaining a bright display screen.

As a structure of the lighting unit, there is an edge light type (also referred to as a light guiding plate type) in which a light guiding plate is disposed on a rear surface of the display element, and a light source is disposed on an end face of the light guiding plate. The edge light type excels in achieving a thin lighting unit and a light emitting surface with a uniform luminance. Therefore, the edge light type is commonly adopted as a type of a liquid crystal unit of the liquid crystal display device used in the notebook-type personal computer or the like in order to give priority to thinness. And, in the liquid crystal display device used in the portable television, the car navigation system and the like, the edge light type using two or more fluorescent discharge tubes, or the edge light type using an L-shaped or a U-shaped fluorescent discharge tube, is commonly adopted in order for the thinness and the luminance to be compatible with each other.

FIG. 3 shows an example of a liquid crystal display device LD which employs a conventional edge light type lighting unit using a fluorescent discharge tube 2, and comprises a lighting unit UT and a liquid crystal display device LD in which a liquid crystal panel 7 or the like is mounted on the lighting unit UT. The lighting unit UT comprises a light guiding plate 1 configured to illuminate the liquid crystal panel 7, a reflecting sheet 3 disposed along a rear surface of the light guiding plate 1 and configured to reflect light from the fluorescent discharge tube 2 toward the liquid crystal panel 7, and a protecting member 5 provided around the fluorescent discharge tube 2.

The reflecting sheet 3 serves to return the light emanating from the rear surface of the light guiding plate 1 into the same to thereby increase illumination light emanating from a light emanating surface thereof, and is typically formed by a white resinous film having high reflectivity. A light source side end portion 3a of the reflecting sheet 3 protrudes from the light guiding plate 1 toward the fluorescent discharge tube 2. If an incident end face 1a of the light guiding plate 1 conforms to a side surface of the light source side end portion 3a of the reflecting sheet 3, an emission line is generated due to the light reflected on the side surface of the light source side end portion 3a. But, generation of the emission line is inhibited by protruding the light source side end portion 3a of the reflecting sheet 3.

A reflector 4 serves to return the light from the fluorescent discharge tube 2 into the light guiding plate 1 and to allow the light to efficiently enter the incident end face 1a of the light guiding plate 1, and is bent in U-shape in cross-section so as to cover the fluorescent discharge tube 2. The reflecting sheet 3 may be structured such that a portion covering a peripheral portion of the fluorescent discharge tube 2 as in the reflector 4, and a portion on the rear surface side of the light guiding plate 1 are provided separately, and are bonded to each other by an adhesive such as a double face adhesive tape.

The protecting member 5 serves to prevent the fluorescent discharge tube 2 from contacting the reflector 4, and is annular so as to be attached to an outer periphery of the fluorescent discharge tube 2 (also referred to as “O ring”). The protecting member 5 is typically made of insulative rubber having elasticity to absorb impact which may be caused by contact and vibration. The protecting member 5 is disposed with a predetermined spacing between the same and the discharge tube 2.

It is necessary to minimize a distance between the fluorescent discharge tube 2 and the incident end face 1a of the light guiding plate 1 to allow the light from the fluorescent discharge tube 2 to efficiently enter the light guiding plate 1. However, since the protecting member 5 is attached to the fluorescent discharge tube 2, the protecting member 5 may contact the light source side end portion 3a of the reflecting sheet 3. In other words, since the reflecting sheet 3 is provided to slightly protrude from the light guiding plate 1 toward the fluorescent discharge tube 2 for the purpose of inhibiting generation of the emission line, the protecting member 5 may contact the light source side end portion 3a of the reflecting sheet 3. When the protecting member 5 contacts the light source side end portion 3a of the reflecting sheet 3, distortion or damage 8 occur in the reflecting sheet 3, and luminance of this portion varies locally, thereby causing that non-uniform luminance and white uneveness due to the distortion and the damage 8 occur on an illuminating surface (on a screen). As used herein, the white uneveness means a condition in which a portion looks locally white as compared to other portion on the screen, which may lead to an inferior product. If a distance between the light source side end portion 3a of the reflecting sheet 3 and the protecting member 5 is increased too much to avoid such a problem, a width of the reflector 4 is required to be increased, thereby deteriorating the luminance, or, the light leaking from between the reflecting sheet 3 and the fluorescent discharge tube 2 is reflected by the reflector 4 on a rear surface side of the reflecting sheet 3 with reflectivity different from that of the reflecting sheet 3, thereby causing the emission line to be generated.

Accordingly, an object of the present invention is to provide a highly reliable lighting unit capable of solving problems such as occurrence or generation of the non-uniform luminance, the white uneveness, and the emission line which may be caused by contact between the reflecting sheet and the protecting member, and a liquid crystal display device using the same.

### DISCLOSURE OF THE INVENTION

A lighting unit according to claim 1 of the present invention comprises a light source, a light guiding plate disposed close to the light source and configured to guide light from the light source, a reflecting sheet disposed along a rear surface of the light guiding plate, and a reflector covering the light source and configured to reflect the light from the light source toward an incident end face of the light guiding plate, the reflecting sheet having a light source side end portion protruding from the incident end face of the light guiding plate, and the light source being provided with a protecting member attached to an outer periphery thereof to allow the light source to be protected, wherein the light source side end portion of the reflecting sheet and the protecting member are located with a spacing between the light source side end portion and the protecting member for preventing contact between the light source side end portion of the reflecting sheet and the protecting member. The spacing for preventing contact between them may be obtained by decreasing a protruding length of the light source side end portion of the reflecting sheet, by displacing the light source, or by decreasing diameters of the light source and the protecting member.

According to the present invention, since the light source side end portion of the reflecting sheet does not contact the protecting member, occurrence of distortion or damage in the reflecting sheet which may be caused by contact between the reflecting sheet and the protecting member can be inhibited.

In the lighting unit according to claim 2 of the present invention, the spacing for preventing contact between the light source side end portion of the reflecting sheet and the protecting member is not larger than five times as large as the diameter of the light source.

According to the present invention, generation of an emission line can be inhibited. If the spacing is larger than five times as large as the diameter of the light source, the emission line is generated, thereby causing non-uniform luminance, but when the spacing is not larger than five times as large as the diameter of the light source, generation of the emission line can be inhibited.

In the lighting unit according to claim 3 of the present invention, the protecting member is provided with a concave portion on a portion of an outer periphery thereof to be opposed to the light source side end portion of the reflecting sheet.

According to the present invention, since the concave portion is formed on the outer periphery of the protecting member, a spacing for preventing contact between the protecting member and the reflecting sheet is provided at the concave portion. Thereby, it is possible to prevent occurrence of distortion or damage in the reflecting sheet which may be caused by contact between the reflecting sheet and the protecting member.

A liquid crystal display device using a lighting unit, according to claim 4 of the present invention, comprises a lighting unit according to any one of claims 1 to 3, and a liquid crystal panel disposed above the lighting unit.

According to the present invention, occurrence of the distortion or the damage in the reflecting sheet which may be caused by contact between the light source side end portion of the reflecting sheet and the protecting member is inhibited, thereby achieving a liquid crystal display device using a highly reliable lighting unit.

### BRIEF DESCRIPTION OF THE DRAWINGS

FIG. 1 is a cross-sectional view showing a liquid crystal display device comprising a lighting unit according to an embodiment of the present invention;

FIG. 2 is a cross-sectional view showing a liquid crystal display device comprising a lighting unit according to another embodiment of the present invention; and

FIG. 3 is a cross-sectional view showing a structure of a conventional lighting unit.

### BEST MODE FOR CARRYING OUT THE INVENTION

Hereinafter, an embodiment of the present invention will be described in detail with reference to the drawings.

As shown in FIG. 1, this embodiment comprises a lighting unit UT, and a liquid crystal display device LD in which a liquid crystal panel or the like is mounted on the lighting unit UT. The lighting unit UT is an edge light type lighting unit, and comprises a light source 2, a light guiding plate 1 disposed close to the light source 2 for guiding light from the light source 2, a reflecting sheet 3 disposed along a rear surface of the light guiding plate 1, and a reflector 4 enclosing the light source 2 and configured to reflect the light from the light source 2 toward an incident end face 1a of the light guiding plate 1.

A fluorescent discharge tube 2 driven by a high frequency alternating current (40 to 100 kHz) to emit light is used as the light source 2. A diameter of the light source 2 of this embodiment is 1.8 mm.

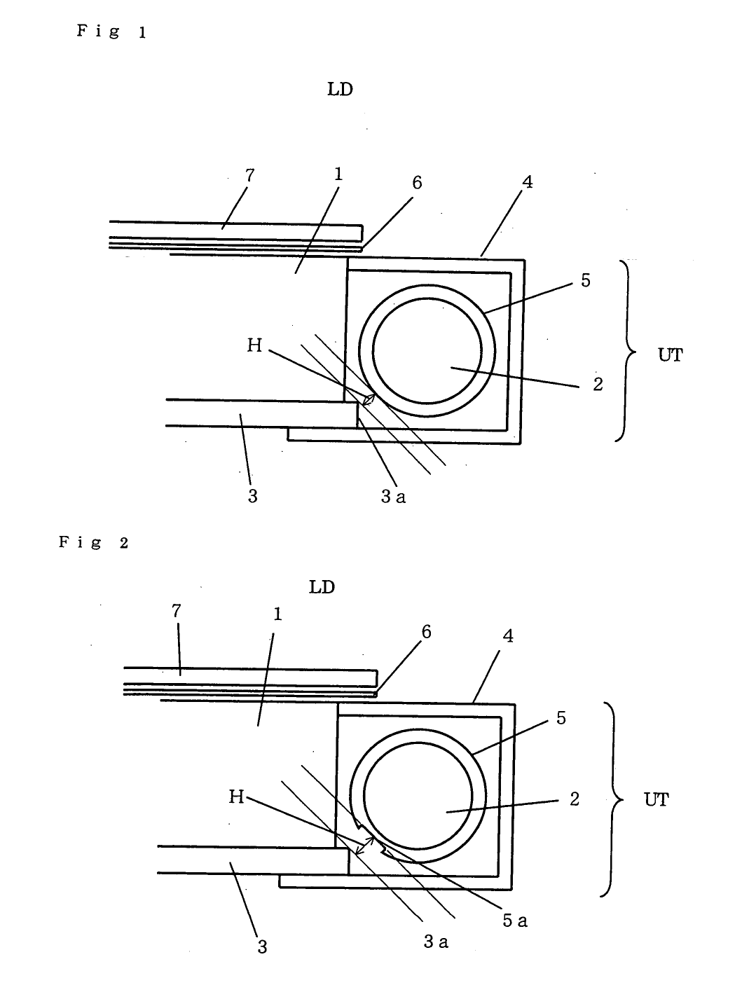

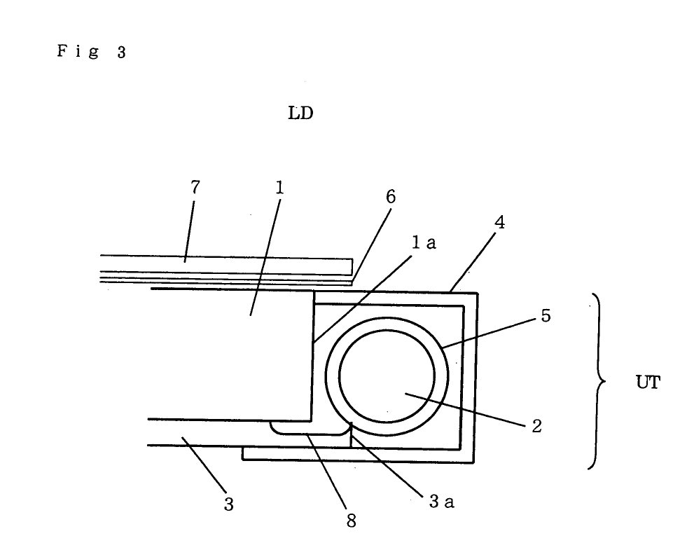

A protecting member 5 for protecting the light source 2 is provided on an outer periphery of the light source 2 so as to be disposed with a predetermined spacing between the protecting member 5 and the light source 2. The protecting member 5 is annular so as to be attached to the outer periphery of the fluorescent discharge tube 2 (also referred to as “O ring”). The protecting member 5 is made of insulative rubber having elasticity to absorb impact which may be caused by contact and vibration. A thickness of the protecting member 5 is 0.2 mm. As shown in FIG. 2, the protecting member 5 may alternatively be provided with a concave portion 5a on a portion of an outer periphery thereof to be opposed to a light source side end portion 3a of the reflecting sheet 3. The concave portions 5a may be formed on the entire outer periphery of the protecting member 5 at predetermined intervals, although at least one of them is required to be formed on the portion of the outer periphery which is opposed to the light source side end portion 3a of the reflecting sheet 3. In this case, it is possible to design a spacing H for preventing contact between the light source side end portion 3a of the reflecting sheet 3 and the protecting member 5 to be not larger than five times as large as the diameter of the light source 2, as described below. This is because, if the spacing H is too large, the light leaking through the spacing H becomes an emission line. Actually, when the spacing H is larger than five times as large as the diameter of the light source 2, the emission line appears. Therefore, the spacing H should be set so that the light source side end portion 3a and the protecting member 5 do not contact each other (0<spacing H), but is preferably as small as possible.

The light guiding plate 1 is disposed close to the fluorescent discharge tube 2 for guiding the light from the fluorescent discharge tube 2, and is made of a material which is optimal in optical characteristics, such as transmissivity and a refractive index or the like required for transmitting light, for example, acrylic.

The reflecting sheet 3 is formed by a white resinous film having high reflectivity, and is bent in U-shape in cross-section to enclose the fluorescent discharge tube 2. The reflecting sheet 3 serves to return the light emanating from the rear surface of the light guiding plate 1 into the same to thereby increase illumination light emanating from a light emitting surface thereof. A light correction sheet 6 is disposed on an illuminating surface side of the light guiding plate 1. The light correction sheet 6 is intended to gain uniform and highly luminous emanating light of the lighting unit UT, and is formed by a diffusion sheet, a prism sheet, and the like. And, a liquid crystal panel 7 is mounted above such lighting unit UT (on an illuminating surface of the light correction sheet 6), thereby constituting the liquid crystal display device LD.

The spacing H is provided between the light source side end portion 3a of the reflecting sheet 3 and the protecting member 5 to prevent contact between them. The spacing H for preventing contact between them may be obtained by decreasing a protruding length of the light source side end portion 3a of the reflecting sheet 3, by displacing the fluorescent discharge tube 2, or by decreasing diameters of the fluorescent discharge tube 2 and the protecting member 5. In other words, the fluorescent discharge tube 2 may be slightly displaced so as to conform to an inner periphery of the reflector 4, which may be semi-circular in cross-section, or the diameters of the fluorescent discharge tube 2 and the protecting member 5 may be decreased as the diameter of the fluorescent discharge tube 2 becomes smaller. The protecting member 5 is attached so as not to contact the light source side end portion 3a of the reflecting sheet 3.

When using the protecting member 5 provided with the concave portion 5a on the outer periphery thereof, it is possible to prevent the protecting member 5 from contacting the reflecting sheet 3 when and after attaching the protecting member 5 to the fluorescent discharge tube 2. Therefore, occurrence of distortion or damage in the reflecting sheet 3 due to contact between the reflecting sheet 3 and the protecting member 5 is inhibited.

It is necessary to design the spacing H for preventing the light source side end portion 3a of the reflecting sheet 3 and the protecting member 5 from contacting each other to be not larger than five times as large as the diameter of the light source. Considering only preventing the contact between the reflecting sheet 3 and the protecting member 5, the spacing H is desirably large. But, if the spacing H is too large, the light leaking through the spacing H becomes the emission line, which may lead to a bad appearance. From an experiment, it has been revealed that, when the spacing H is larger than five times as large as the diameter of the light source, the emission line is generated, thereby causing non-uniform luminance. And, in the liquid crystal display device required to be small, the spacing H is limited in size. Therefore, in order to prevent contact between the reflecting sheet 3 and the protecting member 5, to maintain excellent display accuracy, and to obtain a small device, the spacing H is required to be not larger than five times as large as the diameter of the light source. Since the diameter of the fluorescent discharge tube 2 is 1.8 mm in this embodiment, the spacing H is not larger than 9.0 mm which is five times as large as the diameter. Therefore, 0<spacing H≦9.0 is established.

Although, a straight tube type fluorescent discharge tube 2 is used in the above-described embodiments, the present invention is generally applicable to the edge light type or the like in which an L-type or U-type fluorescent discharge tube is used.

### INDUSTRIAL APPLICABILITY

In accordance with a lighting unit according to the present invention, since a spacing for preventing contact between a light source side end portion of a reflecting sheet and a protecting member is provided, occurrence of distortion or damage in the reflecting sheet which may be caused by contact between the reflecting sheet and the protecting member is reliably inhibited, and it is possible to provide a highly reliable lighting unit capable of solving problems such as occurrence or generation of the non-uniform luminance, the white uneveness, and the emission line which may be caused by contact between the reflecting sheet and the protecting member, and a liquid crystal display device using the same.

1. A lighting unit comprising:
a light source;
a light guiding plate disposed close to the light source and configured to guide light from the light source;
a reflecting sheet disposed along a rear surface of the light guiding plate; and
a reflector covering the light source and configured to reflect the light from the light source toward an incident end face of the light guiding plate,
the reflecting sheet having a light source side end portion protruding from the incident end face of the light guiding plate, and
the light source being provided with a protecting member attached to an outer periphery thereof to allow the light source to be protected, wherein
the light source side end portion of the reflecting sheet and the protecting member are located with a spacing between the light source side end portion and the protecting member for preventing contact between the light source side end portion of the reflecting sheet and the protecting member.

2. The lighting unit according to claim 1, wherein the spacing for preventing contact between the light source side end portion of the reflecting sheet and the protecting member is not larger than five times as large as a diameter of the light source.

3. The lighting unit according to claim 1, wherein the protecting member is provided with a concave portion on a portion of an outer periphery thereof to be opposed to the light source side end portion of the reflecting sheet.

4. A liquid crystal display device comprising:
a lighting unit according to claim 1; and
a liquid crystal panel disposed above the lighting unit.

5. The lighting unit according to claim 2, wherein the protecting member is provided with a concave portion on a portion of an outer periphery thereof to be opposed to the light source side end portion of the reflecting sheet.

6. A liquid crystal display device comprising:
a lighting unit according to claim 2; and
a liquid crystal panel disposed above the lighting unit.

7. A liquid crystal display device comprising:
a lighting unit according to claim 3; and
a liquid crystal panel disposed above the lighting unit.
